(19) United States
(12) Patent Application Publication
(10) Pub. No.: US 2007/0195746 A1
(43) Pub. Date: Aug. 23, 2007

(54) Topology Management, Power Control and Cross-Layer Design for Wireless Mobile Ad Hoc Networks with Directional Antennas

(75) Inventors: Bo Ryu, San Diego, CA (US); Zhensheng Zhang, San Diego, CA (US); Zhuochuan Huang, San Diego, CA (US)

Correspondence Address: FISH & RICHARDSON, PC, P.O. BOX 1022, MINNEAPOLIS, MN, 55440-1022, US

(73) Assignee: SAN DIEGO RESEARCH CENTER, INC., San Diego, CA (US)

(21) Appl. No.: 11/678,551

(22) Filed: Feb. 23, 2007

Related U.S. Application Data
(60) Provisional application No. 60/776,619, filed on Feb. 23, 2006.

(51) Int. Cl. H04Q 7/24

(52) U.S. Cl. 370/338

(57) ABSTRACT

Techniques for implementing systems and methods for topology management, power control and cross-layer design in directional antenna-based wireless mobile ad hoc networks are described. A multiple access control (MAC) system for a directional antenna and time division multiple access communication (DTMAC) node includes a neighbor discovery computer process designed to identify one or more neighbor nodes. The MAC system also includes a make reservation computer process designed to identify and reserve at least one transmission time slot with at least one of the one or more identified neighbor nodes. Further, the MAC system includes a data transmission computer process designed to transmit data to the at least one of the one or more identified neighbor nodes during the at least one reserved transmission time slot.

### CLAIM OF PRIORITY

This application claims priority under 35 USC §119(e) to U.S. Patent Application Ser. No. 60/776,619, filed on Feb. 23, 2006, the entire contents of which are hereby incorporated by reference.

### BACKGROUND

In wireless communications, directional antennas focus the capture and release of electromagnetic energy in significantly narrowed directional lobes. Using a given amount of transmission power, a transmitter can cover a longer yet narrower area, and thus the topology of the network is narrowed. In reception, a receiver can amplify the captured energy in certain directions and thus significantly increase the signal strength in these directions. The directionality of energy capture and release potentially provides higher capacity, lower probability of detection (LPD) and lower degree of interference. To preserve the same range of coverage, transmission power can also be reduced.

### SUMMARY

Topology management includes adjusting the power intensity in different directions and in different scales, or in the same scale as in omni-directional topology control schemes. The present inventors recognized that using topology management, total power can be significantly reduced to preserve the network connectivity. Further, the present inventors recognized that while topology management for wireless or mobile ad hoc networks has been extensively studied, studies for ad hoc networks using directional antennas have been lacking.

The present inventors also recognized that power control can be an issue in mobile/wireless ad hoc networks and in cellular networks, especially in those that are based on Code Division Multiple Access (CDMA) schemes. In wireless mobile ad hoc networks, power control has been applied mainly to multiple access control (MAC) and routing protocols, such as power-aware multi-access protocol with signaling (PAMAS). Other schemes include minimum total power routing (MTPR), which picks the routes with the minimum total power, and minimum battery cost routing (MBCR), which utilizes the sum of the inverse of the battery capacity for all intermediate nodes as the metric upon which the routes is picked.

Another solution reduces the system energy consumption and thus prolongs the battery life of mobile nodes. Furthermore, this solution improves the end-to-end network throughput as compared to other ad-hoc networks in which all mobile nodes use the same transmit power. The improvement is due to the achievement of a tradeoff between minimizing interference ranges, reduction in the average number of hops to reach a destination, reducing the probability of having isolated clusters, and reducing the average number of transmissions including retransmissions due to collisions. Still other solutions are related to power control for various MAC protocols for ad hoc networks. However, none of these solutions is directed to applying power control to a directional antenna and TDMA-based MAC protocol.

Another way to improve performance of wireless networks is to implement a cross-layer design. Such cross layer design has been introduced in ad hoc networks. One solution includes a directional antenna-based MAC/routing protocol set. Another solution involves an interacting and modular network and MAC-layer mechanisms for applying directional antennas to wireless ad hoc networks. However, each of these solutions are limited to random access-based MAC protocols. No solution yet exists for weaving together a directional antenna and TDMA-based MAC protocol and existing routing protocols as well as upper layer protocols.

Consequently, the present inventors have developed systems and methods for topology management, power control and cross-layer design in directional antenna-based wireless mobile ad hoc networks. More generally, the components of topology management, power control and cross-layer design are incorporated into a design for a directional antenna and TDMA-based MAC (DTMAC) protocol. The topology management mechanism reduces interference and routing overhead, and expands network capacity. The power control conserves energy, although may also alleviate interference. Cross-layer design is used to improve network performance. In general, these systems and methods improve the performance, particularly throughput and energy consumption, of a directional antenna and TDMA-based MAC protocol. The improvements are due to a tradeoff among reduced neighbor set, packet-based power reduction and network reachability.

Implementations of the systems and methods described in this specification may include various combinations of the following features.

In one aspect, a multiple access control (MAC) system for a directional antenna and time division multiple access communication (DTMAC) node includes a neighbor discovery computer process designed to identify one or more neighbor nodes. The MAC system also includes a make reservation computer process designed to identify and reserve at least one transmission time slot with at least one of the one or more identified neighbor nodes. Further, the MAC system includes a data transmission computer process designed to transmit data to the at least one of the one or more identified neighbor nodes during the at least one reserved transmission time slot.

Implementations can optionally include one or more of the following features. A MAC system as described above can further include a neighbor selection computer process executable during either the neighbor discovery computer process or the make reservation computer process. The neighbor selection computer process can be designed to identify and select a subset of the one or more neighbor nodes based on one or more transmission criteria. The one or more transmission criteria can include a direction from the DTMAC node to a first node in the subset of the one or more neighbor nodes. Alternatively, the one or more transmission criteria can include a transmission power required to transmit data from the DTMAC node to a first node in the subset of the one or more neighbor nodes.

In another aspect, a multiple access control (MAC) system for a directional antenna and time division multiple access communication (DTMAC) node includes a topology manager designed to adjust physical layer parameters for optimal communication between the DTMAC and one or more neighbor nodes. The MAC system according to this aspect also includes a power controller designed to conserve transmission power and to reduce interference between communications of the DTMAC node and the one or more neighbor nodes.

Implementations can optionally include one or more of the following features. In a MAC system in accordance with the above described another aspect, the physical layer parameters can include an antenna pattern of an antenna of the DTMAC node. Alternatively, the physical layer parameters can include a transmission power of a transceiver of the DTMAC node.

The subject matter described in this specification can be implemented as a method, or as a system or using computer program products, tangibly embodied in information carriers, such as a CD-ROM, a DVD-ROM, a semiconductor memory, and a hard disk. Such computer program products may cause a data processing apparatus to conduct one or more operations described in this specification.

In addition, the subject matter described in this specification can also be implemented as a system including a processor and a memory coupled to the processor. The memory may encode one or more programs that cause the processor to perform one or more of the method acts described in this specification.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a frame structure for DTMAC communications.

FIG. 2 depicts a two-dimensional sequence of neighbor discovery.

Like reference symbols in the various drawings indicate like elements.

### DETAILED DESCRIPTION

This document describes topology management, power control and cross-layer design for enhanced directional antenna- and TDMA-based MAC (DTMAC) protocols. DTMAC performs link (as opposed to node) scheduling. A DTMAC process requires information only from one hop neighbors to schedule a transmission, as only the available slots at the sender and receiver are required to create a transmission schedule for the link. In accordance with embodiments, a system and method applies topology management, power control and cross-layer design to DTMAC techniques.

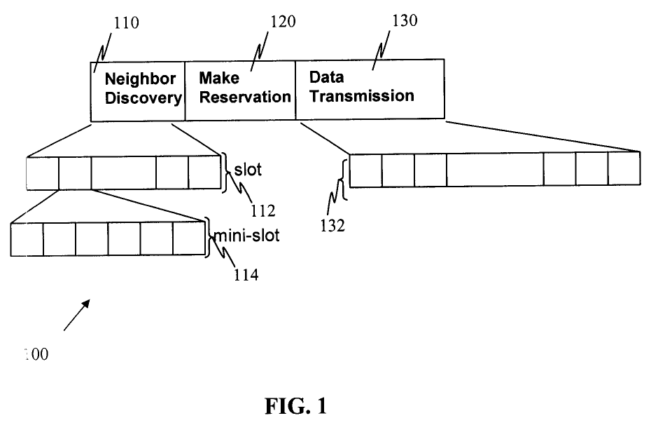

In DTMAC, time is divided into frames, and each frame is divided into multiple sub-frames. FIG. 1 is a block diagram of a frame 100 in DTMAC. FIG. 1 includes three sub-frames 110, 120 and 130. The first sub-frame 110 is devoted for neighbor discovery for detecting new nodes or nodes that have moved away. The second sub-frame 120 is used to make a data reservation between two nodes (not shown), and to reassure the two nodes of their connection detected during the neighbor discovery. The third sub-frame 130 is used for data transmission based at least in part on the data reservation.

Each sub-frame 110, 120 and 130 is further divided into one or more slots 112 and 132. Also, each of the slots (e.g., 112) is further divided into mini-slots 114. For example, the slot 112 within the neighbor discovery sub-frame 110 and/or reservation period includes a number of mini-slots 114. Both the neighbor discovery 110 and reservation 120 sub-frames use a three-way handshake for power negotiation and reservation confirmation. The content of the three-way messages used in neighbor discovery 110 is different from that used to make a reservation 120. The message length in the latter case will typically be longer than the former case. Each mini-slot 114 can accommodate a three-way handshaking message used in both the neighbor discovery 110 and make reservation 120 process.

A pair of nodes (not shown) with directional antennas can communicate directly, provided that a straight line connecting them is contained within both the current transmit beam of one node and the current receive beam of the other node. Thus, the two nodes must point their beams to each other at the same time, and must be in the complementary transmit/receive mode (i.e., one must be transmitting and the other receiving). In a tactical network, communications often exist between terrestrial and airborne nodes at various elevations. As a result, transmit/receive direction needs to be modeled in three-dimension. Let (θ′,φ′) and (θ″,φ″) be the three-dimensional polar coordinates of transmit and receive directions of the two nodes respectively. For narrow-beam antennas, communication between the two nodes requires that the two beams point in opposite directions, and to be in complementary transmit/receive mode, that is:

θ′=(θ″+π) mod 2π and φ′=−φ″

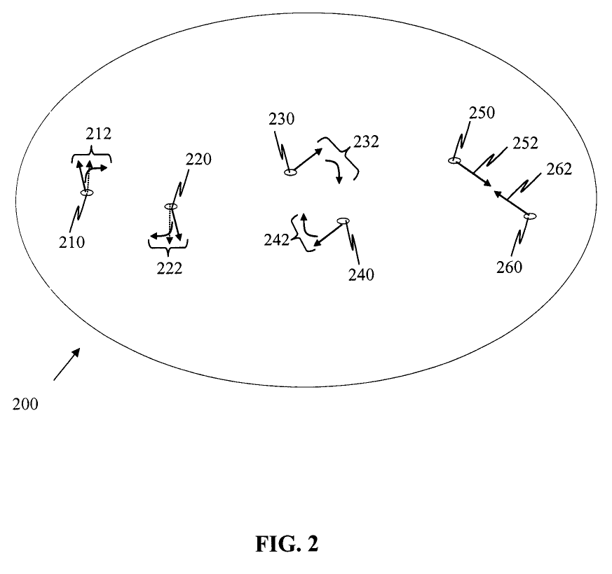

FIG. 2 shows a block diagram of a process 200 for scanning. When scanning, one or more nodes 210, 220, 230, 240, 250 and 260 probe a sequence of directions 212, 222, 232, 242, 252 and 262, as exemplified in FIG. 2, for potential neighbors by transmitting an advertisement in each specified direction. When listening, a node (e.g., 210, 220, 230, 240, 250 and 260) waits for advertisements. If a listening node (e.g., 210, 220, 230, 240, 250 and 260) receives an advertisement, it responds directionally with its own advertisement, and expects to receive an acknowledgement in return, all within a short time interval. The sequence of scanning/listening is pre-determined and synchronized among all nodes 210, 220, 230, 240, 250 and 260 in the network, such that each node (e.g., 210, 220, 230, 240, 250 and 260) is guaranteed to advertise to and receive advertisement from every possible neighbor within a minimum time span.

Each portion of this three-way handshake can be used to exchange power information and refine directional information. In addition, the advertisement messages are used to negotiate future time slots and to reassess reachability if both nodes tentatively agree to become neighbors and to make reservations. Depending upon the amount of time required to go through the sequence of directions and the proportion of time allotted to neighbor discovery during a frame, only a subset of the sequence of directions might be probed in each frame.

When the two nodes (e.g., 250 and 260) agree to reassure their connectivity and make a possible reservation for data transmission, they can also agree as to which node (e.g., one of 250 and 260) will initiate the handshaking process so that the other node (e.g., one of 250 and 260) responds to the initiator. During the handshake, a pair of nodes (e.g., 250 and 260) exchange information on the number of available slots in the data sub-frame and the number of slots required/desired for data transmission, in addition to their transmission/reception power for power control purposes.

Topology Management

In omni-directional antenna-based networks, topology management can reduce power consumption, conserve energy, expand capacity and alleviate interference. In narrow-beam directional antenna-based ad hoc networks, the narrow beam provides low interference, expanded capacity, and low probability of detection, in addition to prolonged communication range and reduced power.

These benefits are achieved by using topology management to modify physical layer parameters, such as power, antenna pattern, etc. Another use of topology management is neighbor selection: by choosing the least number of neighbors necessary to preserve network connectivity, routing overhead, such as is used in route discovery, can be reduced. In omni-directional antenna-based networks, a node's transmission covers all the nodes in its neighborhood. Therefore, packet relay to selected neighbors is achieved by either specifying the receiver inside the transmitted packet (sender-based) or allowing the neighbors receiving the packet (receiver-based) to decide whether it wants to be a neighbor (such that it will relay the packet further). In directional antenna-based networks, a node's transmission typically covers only one neighbor at a time. Therefore, one way of packet relay to selected neighbors is that the sender transmits the packet sequentially to each neighbor it selects.

As described above, DTMAC has three sequentially executed processes: a “neighbor discovery” process for searching for all reachable neighbors, a “make reservation” process in which a time slot is reserved for data transmission for all reachable neighbors to which a packet is addressed, and a “data transmission” process during which data is transmitted. As such, DTMAC is tightly coupled with the concept of “neighbors,” especially in the first two processes. During route discovery, where broadcast packets are dominant, the make reservation process includes attempts to reserve data slot for each of the reachable neighbors. Such traffic involves a bursty load in proportion to the number of neighbors. When the number of neighbors is large, such traffic uses significant overhead, increasing delay and reducing throughput. Therefore, topology management is used to reduce the number of neighbors, while still ensuring the route discovery, via is desirable.

Neighbor selection may be incorporated into the neighbor discovery and/or make reservation processes. Neighbor selection is described below for two nodes, node A and node B. In the neighbor discovery process, two nodes may decide not to meet again in the make reservation process if the scanning node decides not to select the other node as its listening neighbor. In the make reservation process, one node may decide not to relay a broadcast packet to the other node. Consequently, data slots are conserved, either indirectly or directly.

For node A,

(a) In the “neighbor discovery” mini-slot:

Node A discovers a neighbor node B or is discovered by node B with neighbor information NbrInfo(B): <ID(B), MR_Slot(B), Direction(B), Power(B)>. Let node A's current neighbor set be Nbr(A). If B is in Nbr(A), NbrInfo(B) is updated; otherwise a new entry for node B is created. The MR_Slot(B) field specifies two adjacent mini-slots in the make reservation sub-frame. When node A discovers node B, it initiates the make reservation handshake in the left one of the pair of mini-slots; when node is discovered by node B, it responds to the make reservation handshake initiated by node B.

Notation: (X is in N(A))

ID(X): ID of node X

MR_Slot(X): reserved make reservation mini-slot for node X

Direction(X): direction from node A toward node X

Power(X): the power node A uses to transmit to node X

The neighbor selection algorithm is executed to (re)split the Nbr(A) based on the direction and power information of each neighbor X in Nbr(A).

(b) In the “make reservation” mini-slot:

If node A has packets ready, it negotiates with node B via make reservation handshake to decide the number of commonly agreed-upon free slots. Each unicast packet needs one data slot, while each broadcast packet needs a number of data slots (up to the number of active neighbors). Based on this information and the type (unicast or broadcast) of the packets, node A decides on which slots to reserve.

Both A and B associate a counter for each other on the number of continuous failed (i.e. not receiving the first expected handshake message) make reservation handshakes. If the counter is over a threshold, e.g. 2, the associated neighbor is removed from the neighbor set and the neighbor selection algorithm is triggered to re-split neighbors. For successful make reservation handshakes, direction and power information is updated.

(c) In the “data transmission” mini-slot:

During the data transmission, the receiver may choose to update direction and/or power information. The receiver may also increase the associated counter with the data sender and trigger a re-split when the counter is over some threshold.

In DTMAC, it could take a long time (i.e. multiple frames) for a node to meet (discover or revisit) a neighbor in the neighbor discovery process. Once a node meets its neighbor in the neighbor discovery process, the node should attempt a make reservation process with the neighbor as soon as possible, preferably in the immediate make reservation process inside the same frame. Therefore, for delay intolerant applications, it may be better not to discard any discovered neighbors, i.e. a decision is made not to meet again in the make reservation process. In other words, the neighbor discovery process may not be a suitable place for neighbor selection.

A node stores information about every neighbor it discovers, i.e., it schedules a time in the make reservation process to meet the neighbor in some direction. During the neighbor discovery process, if a node discovers a new neighbor, i.e., not currently in its neighbor table (initially empty), it stores into its neighbor table the neighbor's ID, direction, meeting schedule (if available), and/or power. If a node revisits a current neighbor, the entry of that neighbor is updated, e.g., direction, meeting schedule, etc. The neighbor table is maintained during the make reservation and the data transmission processes for mobility, topology management, and other reasons.

For both nodes to have equal opportunity to reserve a data transmission slot as a data sender, mini-slots in the make reservation sub-frame are reserved in pairs for both directions, preferably adjacent to or in the same frame. When the number of slots per make reservation sub-frame is limited, the neighbor discovery process may use make reservation sub-frame in future frames if beneficial. When reserving the mini-slots in the make reservation sub-frame, priority may be given to currently-active neighbors defined elsewhere, i.e., when the currently-visited listening node is an active neighbor and there is no free mini-slot, an occupied mini-slot that is reserved by a candidate neighbor, defined elsewhere, if any, could be taken over.

Upon the end of each neighbor discovery process, i.e., the start of each make reservation process, a neighbor selection algorithm is executed to select a set of neighbors from current neighbors (as specified by the current neighbor table) as active neighbors. The active neighbors constitute the active neighbor set; the neighbors that are not selected are candidate neighbors constituting the candidate neighbor set. In other words, the neighbor selection algorithm splits current neighbors into active neighbors (first neighbor set) and candidate neighbors (second neighbor set). During the make reservation process, as significant changes occur to the current neighbor table, such as a joining by or leaving of some active neighbor or mobility of another neighbor, the neighbor selection algorithm is triggered to re-split current neighbors. For example, if a node's neighbor fails to complete a handshake a certain number of times, the link between the node and its neighbor is very likely no longer reliable and thus the node removes its neighbor and triggers a re-split. Though the neighbor selection algorithm could be triggered in neighbor discovery and/or data transmission process too, no significant impact is encountered.

Active neighbors are selected neighbors to which a node relays a broadcast packet. During a make reservation handshake, when a node wants to transmit a broadcast packet, the node reserves a sequence of slots, one for each active neighbor, in the data transmission sub-frame to be used by a unicast transmission from the node to its active neighbor.

The goal of the neighbor selection algorithm is to achieve maximum node connectivity with the least number of active neighbors. The level of node connectivity is evaluated differently for different topology management schemes. For example, for a CBTC scheme, the level of node connectivity is evaluated by the maximum angular gap a, the lower the better, down to α=2π/3. For K-Neigh, the level of node connectivity is evaluated by the number of neighbors N, the higher the better, up to N=8 or 9 practically. For a YAO-graph scheme, the level of node connectivity is evaluated by the number of π/3 sectors with at least a nod inside, the higher the better, up to 6. The plan is to use a YAO-graph scheme first since it has the feature of bounded node degree. CBTC may be the next-best choice. A few example algorithms are presented below in Tables 1 and 2.

TABLE 1
YAO-Graph Based Algorithm

(a) YAO-graph based

| | |
|---|---|
| 1) | Choose a random direction (e.g., south) to be relative direction |
| | of zero (“0”) degree. |
| 2) | Divide the 360 degree angular area into six identical sectors |
| | with rays in direction, 0 degree, 60 degree, 120 degree, . . . , |
| | 300 degree. |
| 3) | The six sectors correspond to angular areas [0, 60), |
| | [60, 120), [120, 180), . . . , [300, 360), respectively. |
| 4) | Within every one of the six sectors, choose the closest |
| | neighbor if any. Label the chosen neighbors as active neighbors. |
| 5) | The neighbors that are not labeled are termed as candidate |
| | neighbors. |

TABLE 2
CBTC-Based Algorithm

(b) CBTC-based

```
1)  Let CBTC's threshold be ε.
2)  Choose a random direction (e.g., south) to be relative direction
    of zero (“0”) degree.
3)  Let the node be N and its neighbors be N1, N2, . . . , Nk.
4)  Let A = {N1, N2, . . . , Nk} be the active neighbor set.
5)  Let the angle (in degree) of ray N → Ni, where i = 1, 2, . . . , k,
    be αi.
6)  Sort α1, α2, . . . , αk with increasing order to get β1, β2, . . . ,
    βk.
7)  Let the neighbor corresponding to βi be Mi, where i =
    1, 2, . . . , k.
8)  Let δ1 = β2 − β1, δ2 = β3 − β2, . . . , δk = β1 − βk.
9)  Let γa = max (δ1, . . . , δk), γi = min (δ1, . . . , δk).
10) if γi >= ε, return A and exit.
11) Say δi = γa, let p = i.
12) if δp >= ε, p = p mod k +1.
13) while (p not equal to i) {
      a. if δp >= ε then p = p mod k+1
      b. else {
          i. S = δp;
          ii. q = p mod k +1;
          iii. while (S + δq < ε) {
              1. A −= {Mq};
              2. S += δq;
              3. q = p mod k + 1;
            }
            p = q;
        }
    }
          Return A and exit.
```

Power Control

DTMAC incorporates power control to conserve energy and reduce interference. In DTMAC, power control is implemented at the packet level, i.e., power stays the same throughout packet transmission. When a receiver receives a packet from a sender, it knows the received power as well as the power at which the packet was transmitted, which is encapsulated inside the packet. Based on these two power levels, as well as the receiver's receiving power threshold, the receiver is able to recommend whether the sender should have used higher or lower power. To account for the change in the communication link budget, the recommended power is higher than the minimum power necessary for receiving.

As an example, between two communicating nodes A and B, every time node A sends a packet to node B, node A encapsulates the transmission power txpwr inside the packet. Once node B receives the packet, it checks the received power rxpwr and extracts the txpwr from the packet. For node B to receive the packet, rxpwr should be greater than rxthreshold, where rxthreshold is the minimum power needed to transform the waveform into the packet correctly. Let δ=rxpwr−rxthreshold; and let rxbuf be greater than, most of the time, a change in link budget for directed link from node A to node B between their adjacent visits. This change in link budget is typically very small unless node A and node B are very close to each other. Introducing rxbuf allows for a change in the communication path to adapt due to various factors including mobility and interference, by providing a buffer over the reception power threshold. By doing so, the links between pairs of neighbors are more stable and neighbors are more likely to see each other in their reserved slots.

The value of rxbuf could be simply set to be common to all pairs of nodes or tied to each pair of node.

If δ<0, the packet is lost; If δ>=0, the packet is received and a transmission power of txpwrrec=txpwr+(rxbuf−δ) is recommended for node A.

$$\begin{matrix}Note that txpwrrec = txpwr + rxbuf - rxpwr + rxthreshold \\ = ( txpwr - rxpwr ) + ( rxthreshold + rxbuf )\end{matrix}$$

In general:

rxpwr=txpwr+tx_antenna_effective_gain−pathloss+rx_antenna_effective_gain−rx_noise_floor−fading_margin

and txpwr−rxpwr>0.

In DTMAC, neighbor discovery and make reservation each have three-way handshakes. With packet exchange, node B may send back its recommended power for node A right away in the response packet with some power. If communication paths in both directions between node A and node B are similar, and node A and node B have the same rxthreshold (we assume that in DTMAC), node B can send back the packet with the power it recommends for node A, otherwise it could use its maximum power to ensure delivery of the packet. Data transmission from node A to node B uses the most recent txpwr that node B recommended to node A. Since data transmission is a dominant user of frames, the energy saved on data transmission is significant.

Power control is applied to handshake messages in both the neighbor discovery and the make reservation process, as illustrated in Table 3 below.

TABLE 3
Power Control in Handshake Messages

ND Handshake step 1
node1 → node2 (transmitted with maxpwr1)
<maxpwr1> // maximum transmission power for node1
ND Handshake step 2
node2 receives packet (<maxpwr1>) transmitted with
maxpwr1 with rxpwr2
txpwr1 = maxpwr1 − rxpwr2 + rxbuf12 + rxthreshold2
node1 ← node 2 (transmitted with maxpwr2)
<maxpwr2> // maximum transmission power for node2
<txpwr1> // recommended power for node1
ND Handshake step 3
node1 receives packet (<maxpwr2>, <txpwr1>) transmitted with
maxpwr2 with rxpwr1
node1 records power to node2 as txpwr1
txpwr2 = txpwr2 − rxpwr1 + rxbuf21 + rxthreshold1
node1 → node 2 (with txpwr1 or maxpwr1)
<txpwr2> // recommended power for node2
node2 records power to node1 as txpwr2
MR Handshake step 1
node1 → node2 (transmitted with txpwr1)
<txpwr1> // stored power to node2 for node1
MR Handshake step 2
node2 receives packet (<txpwr1>) transmitted with txpwr1 with rxpwr2
txpw1′ = txpwr1 − rxpwr2 + rxbuf12 + rxthreshold2
node2 → node 1 (transmitted with txpwr2)
<txpwr2> // stored power to node 1 for node2
<txpwr1′> // recommended power for node1
MR Handshake step 3
node1 receives packet (<txpwr2>, <txpwr1′>) transmitted with
txpwr2 with rxpwr1
node1 records power to node2 as txpwr1′
node1 → node2 (transmitted with txpwr1′)
<txpwr2′> // recommended power for node2
txpwr2′ = txpwr2 − rxpwr1 + rxbuf21 + threshold1
node2 records power to node1 as txpwr2′

Cross-Layer Design

In general, DTMAC interfaces with topology management via the neighbor set and the set of active neighbors. With topology management, an active neighbor set is maintained for every node. When a node needs to broadcast, it multicasts only to the nodes in its active neighbor set. For omni-directional antenna-based MAC protocols, such multicasts can be achieved by one transmission of a packet having information specifying the targeting nodes. For narrow-beam directional antenna-based MAC protocols, such multicasts need to be resolved into multiple unicasts, one for each neighbor. Therefore, reducing the number of neighbors could significantly save time required for broadcasting. In the meantime, with topology management such benefits are achieved without sacrificing the network connectivity.

The number of neighbors of a node is related to the number of mini-slots in make reservation sub-frame. That is, given a requirement of reserving make reservation mini-slot in the neighbor discovery sub-frame in the same frame, the number of neighbors cannot exceed the number of mini-slots in the make reservation sub-frame. Preferably, the number of neighbors is half or less than the number of mini-slots.

Routing protocols for ad hoc networks, such as AODV and OLSR, have significant routing overhead, mostly route discovery packets in the form of broadcasts. For narrow-beam directional antenna-based MAC protocols, such broadcast needs to be resolved into multiple unicasts. The resolution could be implemented either in the routing protocol or between the routing and MAC interface. In preferred exemplary embodiments, the latter approach is adopted such that the MAC protocol is able to work with any routing protocols seamlessly. To support this approach, individual data queues are implemented, one for each active neighbor, instead of having a single data queue typically. Every time a broadcast packet arrives from the network layer down to the MAC layer, it is removed from the network layer and a unicast packet for each active neighbor is created and inserted into its corresponding data queue.

Queuing support is typically available for mobile ad hoc networks in the form of two priority-based queues, the higher one for control packets and the lower one for data packets. The queuing support is fairly simple since topology and thus link availability/quality is relatively dynamic. The queuing support is implemented in the network layer and the MAC layer does not have queuing support.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a propagated signal or a computer readable medium. The propagated signal is an artificially generated signal, e.g., a machine-generated electrical, optical, or electromagnetic signal, that is generated to encode information for transmission to suitable receiver apparatus for execution by a computer. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by an form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although a few embodiments have been described in detail above, other modifications are possible. Other embodiments may be within the scope of the following claims.

What is claimed is:

1. A multiple access control (MAC) system for a directional antenna and time division multiple access communication (DTMAC) node, the MAC system comprising:
a neighbor discovery computer process configured to identify one or more neighbor nodes;
a make reservation computer process configured to identify and reserve at least one transmission time slot with at least one of the one or more identified neighbor nodes; and
a data transmission computer process configured to transmit data to the at least one of the one or more identified neighbor nodes during the at least one reserved transmission time slot.

2. A MAC system in accordance with claim 1), further comprising a neighbor selection computer process that is executable during either the neighbor discovery computer process or the make reservation computer process, the neighbor selection computer process configured to identify and select a subset of the one or more neighbor nodes based on one or more transmission criteria.

3. A MAC system in accordance with claim 2), wherein the one or more transmission criteria include a direction from the DTMAC node to a first node in the subset of the one or more neighbor nodes.

4. A MAC system in accordance with claim 2), wherein the one or more transmission criteria include a transmission power required to transmit data from the DTMAC node to a first node in the subset of the one or more neighbor nodes.

5. A multiple access control (MAC) system for a directional antenna and time division multiple access communication (DTMAC) node, the MAC system comprising:
a topology manager configured to adjust physical layer parameters for optimal communication between the DTMAC and one or more neighbor nodes; and
a power controller configured to conserve transmission power and to reduce interference between communications of the DTMAC node and the one or more neighbor nodes.

6. A MAC system in accordance with claim 5), wherein the physical layer parameters include an antenna pattern of an antenna of the DTMAC node.

7. A MAC system in accordance with claim 5), wherein the physical layer parameters include a transmission power of a transceiver of the DTMAC node.

8. A method for topology management, power control and cross-layer design in a multiple access control (MAC) system for a directional antenna and time division multiple access communication (DTMAC) node, the method comprising:
identifying one or more neighbor nodes;
identifying and reserving at least one transmission time slot with at least one of the one or more identified neighbor nodes; and
transmitting data to the at least one of the one or more identified neighbor nodes during the at least one reserved transmission time slot.

9. A method in accordance with claim 8), further comprising identifying and selecting a subset of the one or more neighbor nodes based on one or more transmission criteria.

10. A method in accordance with claim 9), wherein the identifying and selecting a subset of the one or more neighbor nodes based on the one or more transmission criteria include identifying and selecting a subset of the one or more neighbor nodes based on a direction from the DTMAC node to a first node in the subset of the one or more neighbor nodes.

11. A method in accordance with claim 9), wherein the identifying and selecting a subset of the one or more neighbor nodes based on the one or more transmission criteria include identifying and selecting a subset of the one or more neighbor nodes based on a transmission power required to transmit data from the DTMAC node to a first node in the subset of the one or more neighbor nodes.

12. A method for topology management, power control and cross-layer design in a multiple access control (MAC) system for a directional antenna and time division multiple access communication (DTMAC) node, the method comprising:
adjusting physical layer parameters for optimal communication between the DTMAC and one or more neighbor nodes; and
conserving transmission power and reducing interference between communications of the DTMAC node and the one or more neighbor nodes.

13. A method in accordance with claim 12), wherein the adjusting physical layer parameters comprises adjusting an antenna pattern of an antenna of the DTMAC node.

14. A method in accordance with claim 12), wherein the adjusting physical layer parameters comprises adjusting a transmission power of a transceiver of the DTMAC node.

15. A computer program product, encoded on a computer-readable medium, operable to cause data processing apparatus to perform operations for topology management, power control and cross-layer design in a multiple access control (MAC) system for a directional antenna and time division multiple access communication (DTMAC) node, the operations comprising:
identifying one or more neighbor nodes;
identifying and reserving at least one transmission time slot with at least one of the one or more identified neighbor nodes; and
transmitting data to the at least one of the one or more identified neighbor nodes during the at least one reserved transmission time slot.

16. A computer program product in accordance with claim 15), further operable to cause a data processing apparatus to perform operations comprising identifying and selecting a subset of the one or more neighbor nodes based on one or more transmission criteria.

17. A computer program product in accordance with claim 16), wherein the product is operable to cause a data processing apparatus to identify and select a subset of the one or more neighbor nodes based on the one or more transmission criteria including a direction from the DTMAC node to a first node in the subset of the one or more neighbor nodes.

18. A computer program product in accordance with claim 16), wherein the product is operable to cause a data processing apparatus to identify and select a subset of the one or more neighbor nodes based on the one or more transmission criteria include a transmission power required to transmit data from the DTMAC node to a first node in the subset of the one or more neighbor nodes.

19. A computer program product, encoded on a computer-readable medium, operable to cause a data processing apparatus to perform operations for topology management, power control and cross-layer design in a multiple access control (MAC) system for a directional antenna and time division multiple access communication (DTMAC) node, the operations comprising:
adjusting physical layer parameters for optimal communication between the DTMAC and one or more neighbor nodes; and
conserving transmission power and reducing interference between communications of the DTMAC node and the one or more neighbor nodes.

20. A computer program product in accordance with claim 19), wherein the product is operable to cause a data processing apparatus to adjust physical layer parameters comprising an antenna pattern of an antenna of the DTMAC node.

21. A computer program product in accordance with claim 19), wherein the product is operable to cause a data processing apparatus to adjust physical layer parameters comprising a transmission power of a transceiver of the DTMAC node.
